(19) United States
(12) Patent Application Publication
(10) Pub. No.: US 2024/0023013 A1
(43) Pub. Date: Jan. 18, 2024

(54) Methods and Apparatus for Service Assurance for Time-Restricted Short-Lived Networks

(71) Applicant: Huawei Technologies Co., Ltd., Shenzhen (CN)

(72) Inventors: Zhixian Xiang, Frisco, TX (US); Khosrow Tony Saboorian, Plano, TX (US)

(21) Appl. No.: 18/474,277

(22) Filed: Sep. 26, 2023

Related U.S. Application Data
(63) Continuation of application No. PCT/US2022/024844, filed on Apr. 14, 2022.
(60) Provisional application No. 63/176,050, filed on Apr. 16, 2021.

(51) Int. Cl. H04W 48/18

(52) U.S. Cl. CPC H04W 48/18

(57) ABSTRACT

A UE may receive active service time information from a network having business relationship with a home network of the UE. The network may be a short-lived network that is created on-demand and lasts for a period of time. The active service time information may indicate an expiration time of operation of the network or a service provided by the network. The UE may determine whether to select the network for access based on the active service time information and a network selection policy that includes a requirement related to network active service time. The UE may select the network, and access the network according to the active service time information.

### CROSS-REFERENCE TO RELATED APPLICATIONS

This patent application is a continuation of International Patent Application No. PCT/US2022/024844, filed on Apr. 14, 2022, and entitled “Methods and Apparatus for Service Assurance for Time-restricted Short-lived Networks,” which claims priority to U.S. Provisional Application No. 63/176,050, filed on Apr. 16, 2021, and entitled “Methods and Apparatus for Service Assurance for Time-restricted Short-lived Networks,” applications of which are hereby incorporated by reference herein as if reproduced in their entireties.

### TECHNICAL FIELD

The present disclosure relates generally to wireless communications, and in particular embodiments, to techniques and mechanisms for service assurance for time-restricted short-lived networks.

### BACKGROUND

Wireless networks, as part of a bigger evolving integrated service ecoystem, are continuing to be evolved to satisfy various new emerging applications or services as well. 3GPP system architecture working group (SA1 WG) has started a new study on Personal Internet of Things (IoT) networks (PINs). PINs are similar to very small-scale private networks with a limited number of devices to communicate with each other within a small area, and can be deployed in a more dynamic and flexible way. Many PINs can be deployed at home or small enterprise venues for providing various services to consumer IoT devices, such as home automation devices, wearable devices, and so on, and can be set up quickly for a short period time. It is noticed that various such types of private networks are being considered for wireless communications. These types of private network may be created flexibly for providing specific services for a specific period of time. It is thus desirable to develop mechanism to facilitate communications with these networks.

### SUMMARY

Technical advantages are generally achieved, by embodiments of this disclosure which describe a method and apparatus for service assurance for time-restricted short-lived networks.

In accordance with one aspect of the present disclosure, a method is provided that includes: receiving, by a user equipment (UE), active service time information of a first network that is broadcast by the first network, the active service time information indicating an expiration time of operation of the first network or a service provided by the first network; and determining, by the UE, whether to select the first network for access based on the active service time information and a network selection policy, the network selection policy comprising information indicating one or more requirements that are based on network active service time.

Optionally, in any of the preceding aspects, the active service time information comprises one or more of following: an operation duration of the first network, a remaining operation time of the first network, an operation starting time of the first network, an operation ending time of the first network, a notification of an end of the operation of the first network, a counter value reduced by a pre-defined number at a pre-defined interval, an operation duration of the service, a starting time of the service, a remaining operation time of the service, an ending time of the service, or a notification of an end of the service.

Optionally, in any of the preceding aspects, the network selection policy specifies that a network is selectable by the UE when the network satisfies the one or more requirements.

Optionally, in any of the preceding aspects, the one or more requirements comprise: a minimum remaining operation time required for a network selectable by the UE, or a restriction on starting and ending time of operation of a network selectable by the UE.

Optionally, in any of the preceding aspects, the network selection policy is received by the UE in a UE parameter update (UPU) message, a UE configuration update (UCU) message, or a control message for network selection configuration.

Optionally, in any of the preceding aspects, the network selection policy is pre-configured in the UE.

Optionally, in any of the preceding aspects, the network selection policy is pre-configured in the UE by a user of the UE.

Optionally, in any of the preceding aspects, the method further includes: upon determining to access the first network, setting, by the UE, a timer according to the expiration time of the operation of the first network or the service; and accessing, by the UE, the network for a first service according to the timer.

Optionally, in any of the preceding aspects, the method further includes: terminating, by the UE, the first service with the first network when or before the timer expires.

Optionally, in any of the preceding aspects, the method further includes: initiating, by the UE before the timer expires, a service continuity procedure to move the first service from the first network to a second network.

Optionally, in any of the preceding aspects, the method further includes: continuing, by the UE when the timer expires, the first service with the second network.

Optionally, in any of the preceding aspects, the method further includes: requesting, by the UE, to extend an expiration time of the first service for the UE.

Optionally, in any of the preceding aspects, the method further includes: updating, by the UE, the timer according to an extended expiration time of the first service.

Optionally, in any of the preceding aspects, the method further includes: receiving, by the UE, updated active service time information of the first network.

Optionally, in any of the preceding aspects, the active service time information is received in a system information block (SIB).

In accordance with another aspect of the present disclosure, a method is provided that includes: receiving, by a user equipment (UE), active service time information of a first network, the active service time information indicating an expiration time of operation of the first network or a service provided by the first network; and accessing, by the UE, the first network for a first service according to the active service time information and a network selection policy, the network selection policy comprising information indicating one or more requirements that are based on network active service time.

Optionally, in any of the preceding aspects, the active service time information comprises one or more of following: an operation duration of the first network, a remaining operation time of the first network, an operation starting time of the first network, an operation ending time of the first network, a notification of an end of the operation of the first network, a counter value reduced by a pre-defined number at a pre-defined interval, an operation duration of the service, a starting time of the service, a remaining operation time of the service, an ending time of the service, or a notification of an end of the service.

Optionally, in any of the preceding aspects, receiving the active service time information comprises: receiving, by the UE, the active service time information during a first procedure for network registration, service request, service modification or service termination with the first network, or during a second procedure for packet data unit (PDU) session establishment, PDU session modification or PDU session termination with the first network.

Optionally, in any of the preceding aspects, the method further includes: setting, by the UE, a timer according to the expiration time of the operation of the first network or the service.

Optionally, in any of the preceding aspects, the method further includes: terminating, by the UE, the first service with the first network when or before the timer expires.

Optionally, in any of the preceding aspects, the method further includes: initiating, by the UE before the timer expires, a service continuity procedure to move the first service from the first network to a second network.

Optionally, in any of the preceding aspects, the method further includes: continuing, by the UE when the timer expires, the first service with the second network.

Optionally, in any of the preceding aspects, the method further includes: updating, by the UE, the timer according to an updated expiration time of the first service.

Optionally, in any of the preceding aspects, the method further includes: requesting, by the UE, to extend an expiration time for the first service.

Optionally, in any of the preceding aspects, the method further includes: receiving, by the UE, updated active service time information of the first network.

Optionally, in any of the preceding aspects, the method further includes: determining, by the UE, whether to access the first network based on the active service time information and the network selection policy.

Optionally, in any of the preceding aspects, the network selection policy specifies that a network is selectable by the UE when the network satisfies the one or more requirements.

Optionally, in any of the preceding aspects, the one or more requirements comprise: a minimum remaining operation time required for a network selectable by the UE, or a restriction on starting and ending time of operation of a network selectable by the UE.

Optionally, in any of the preceding aspects, the network selection policy is received by the UE in a UE parameter update (UPU) message, a UE configuration update (UCU) message, or a control message for network selection configuration.

Optionally, in any of the preceding aspects, the network selection policy is pre-configured in the UE.

Optionally, in any of the preceding aspects, the network selection policy is pre-configured in the UE by a user of the UE.

In accordance with another aspect of the present disclosure, a method is provided that includes: transmitting, by a first network, active service time information indicating an expiration time of operation of the first network or a service provided by the first network, the active service time information enabling one or more user equipments (UEs) to determine whether to access the first network for one or more services provided by the first network; and providing, by the first network, a first service to a first UE according to the expiration time.

Optionally, in any of the preceding aspects, the active service time information comprises one or more of following: an operation duration of the first network, a remaining operation time of the first network, an operation starting time of the first network, an operation ending time of the first network, a notification of an end of the operation of the first network, a counter value reduced by a pre-defined number at a pre-defined interval, an operation duration of the service, a starting time of the service, a remaining operation time of the service, an ending time of the service, or a notification of an end of the service.

Optionally, in any of the preceding aspects, the active service time information is transmitted: in a system information block (SIB); during a procedure for network registration, service request, service modification or service termination of the first UE with the first network; or during a procedure for packet data unit (PDU) session establishment, PDU session modification or PDU session termination of the first UE with the first network.

Optionally, in any of the preceding aspects, the method further includes: receiving, by the first network from the first UE, a registration request for registering the UE with the first network, the registration request indicating that the first network is selected by the first UE.

Optionally, in any of the preceding aspects, the method further includes: receiving, by the first network from the first UE, a request to extend the expiration time for the first service.

Optionally, in any of the preceding aspects, the method further includes: receiving, by the first network from the first UE, information indicating that the first UE terminates the first service with the first network before the expiration time.

Optionally, in any of the preceding aspects, the method further includes: sending, by the first network, updated active service time information of the first network.

In accordance with another aspect of the present disclosure, an apparatus is provided, which includes: a non-transitory memory storing instructions, and at least one processor in communication with the memory, where the at least one processor configured, upon execution of the instructions, to perform a method of any of the preceding aspects.

In accordance with another aspect of the present disclosure, a non-transitory computer-readable media is provided that stores computer instructions. The computer instructions, when executed by one or more processors, cause the one or more processors to perform a method of any of the preceding aspects.

In accordance with another aspect of the present disclosure, a system is provided that includes a first network; and a user equipment (UE) in communication with the first network. The first network is configured to perform: transmitting active service time information indicating an expiration time of operation of the first network or a service provided by the first network; and the UE is configured to perform: determining whether to access the first network for one or more services provided by the first network based on the active service time information and a network selection policy.

Aspects of the present disclosure provide a mechanism for a short-lived network to convey information related to its life span to UEs. This facilitates the UEs to utilize services provided by the short-lived network without experiencing sudden or unexpected interruption of the services, enables the UEs to timely take actions regarding the services, and improves user experience of the UEs.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of example wearable personal Internet of Things networks (PINs);

FIG. 2 illustrates a diagram of an example localized service system;

FIG. 3 is a flow diagram illustrating embodiment interactions between a UE and networks, highlighting broadcast of active service time information of a short-lived network and network selection based on the active service time information;

FIG. 4 is a flow diagram illustrating embodiment interactions between UEs and networks, highlighting broadcast of active service time information of a short-lived network and network selection based on the active service time information;

FIG. 5 is a flow diagram illustrating embodiment interactions between a UE and networks, highlighting individual transmission of the active service time information of a short-lived network;

FIG. 6 is a diagram of embodiment UE operations, highlighting the use of active service time by a UE;

FIG. 7 is a flow diagram of embodiment UE operations, highlighting network selection based on active service time;

FIG. 8 is a flow diagram of embodiment UE operations, highlighting network access based on active service time;

FIG. 9 is a flow diagram of an embodiment network operation;

FIG. 10 is a block diagram of an embodiment communications system;

FIG. 11A is a block diagram of an embodiment electronic device;

FIG. 11B is a block diagram of an embodiment base station; and

FIG. 12 is a block diagram of an embodiment computing system.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Short-lived networks have emerged for providing versatile services with flexible settings. A short-lived network may be created dynamically on demand and last for a limited period of time, e.g., hours. Thus, it is desirable for a UE to know the life span of a short-lived network and/or services it provides, so that the UE may receive the services of the network without experiencing unexpected interruption. The UE may also determine whether to select a short-lived network based on the remaining life of the short-lived network, or move an ongoing service to another network when the short-lived network is approaching its end of operation.

Embodiments of the present disclosure provide mechanisms that allow a short-lived network to provide active service time information of the network to UEs who are interested in selecting and accessing this network, during different interaction phases (e.g., phases for network selection, network registration, session establishment, and so on) between the UEs and the network. The active service time information may be information related to operation time of the network and/or operation time of a service provided by this network, e.g., life span of the network or the service.

In some embodiments, a UE may receive active service time information from a network having business relationship with a home network of the UE. The network may be a short-lived network that is created on-demand and lasts for a period of time. The active service time information may indicate an expiration time of operation of the network or a service provided by the network. The UE may determine whether to select the network for access based on the active service time information and a network selection policy that includes a requirement related to network active service time. The UE may select the network, and access the network according to the active service time information.

Embodiments of the present disclosure facilitate UEs to utilize services provided by a short-lived network so that the UEs does not experience sudden or unexpected interruption of the services, enables the UEs to timely take actions regarding the services, and improves user experience of the UEs.

3GPP system aspect working group (SA1 WG) has started a new study on Personal Internet of Things (IoT) networks (PINs, or personal IoT networks). This study item (SI) on PINs was proposed by OPPO on Jun. 30-Jul. 3, 2020, with an approved SID: SP-200592, and entitled “Revised SID New WID on Study on Personal IoT Networks”, which is herein incorporated by reference. More information of this SI is provided in Annex A at the end of the description.

PINs are private networks having a limited number of devices that communicate with each other within a small area. A PIN may be set up quickly for providing services for a (short) period time. PINs may be deployed at home or small enterprise venues in a dynamic and flexible way for providing services to consumer IoT devices, such as home automation devices, wearable devices, and so on. A PIN is different from a hotspot. For example, a communication method used in a PIN may be UE-to-UE direct communication (e.g., using PC5), or may include a UE connected to a hotspot, a 5G base station or an access point. As another example, a PIN is a 5G network using 5G technologies, while a hotspot is a Wi-Fi network.

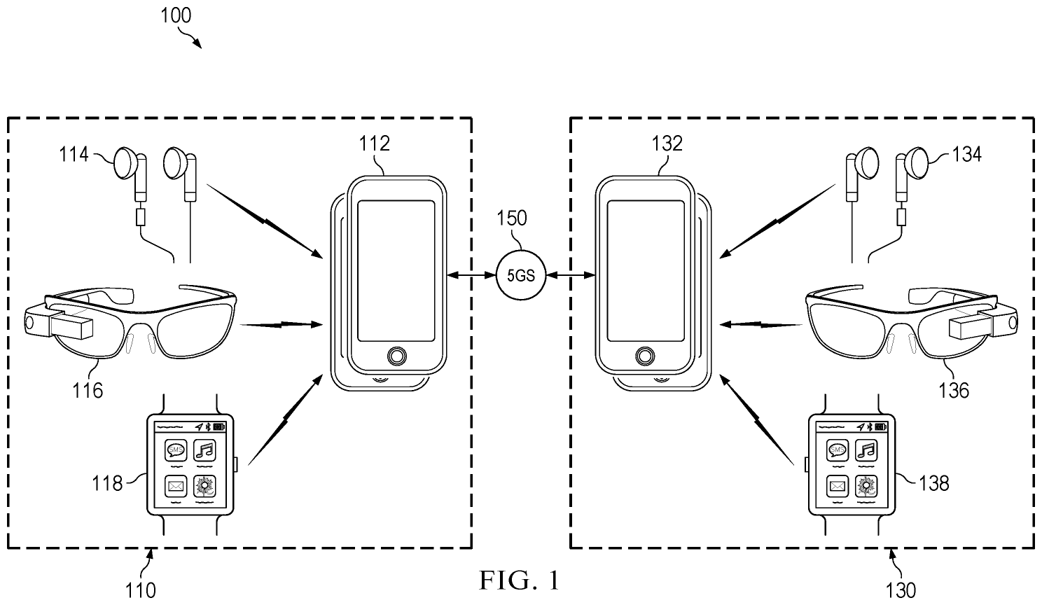

FIG. 1 illustrates a diagram 100 of example wearable PINs. FIG. 1 shows two PINs 110 and 130, each of which communicates with a 5G system (5GS) 150. The PINs 110 and 130 may also be referred to as wearable PINs, as they include wearable devices. The PIN 110 includes cell phones 112, and one of the cell phones 112 may be used to set up the PIN 110. The PIN 110 also includes ear buds 114, virtual reality (VR) glasses 116, and a smart watch 118, all of which may be configured to communicate with the cell phones 112 via the PIN 110. Similarly, the PIN 130 includes cell phones 132, and one of the cell phones 132 may be used to set up the PIN 130. The PIN 130 also includes ear buds 134, virtual reality (VR) glasses 136, and a smart watch 138, all of which may be configured to communicate with the cell phones 132 via the PIN 130. As an example, the PIN 110 may be created by a user of the cell phone 112 when the user wants to play a game, and then be ended after the game.

A 3GPP SA1 new use case proposed by Futurewei and Phillips on dynamic creation of an on-demand PIN at home were adopted into 3GPP SA1 TR23.859 (V18.1.0), which is herein incorporated by reference. This use case is provided in Annex B at the end of the description. In this use case, authorized mobile devices, such as smartphones, tablets, and customer premises equipments (CPEs), can be used as a PIN gateway to dynamically create and manage an on-demand temporary PIN. This on-demand PIN not only provides connectivity to devices in the proximity, but also provides more flexibility and authority to a PIN-user for managing the PIN. For example, the PIN-use may decide which devices are to be connected into this PIN, manage a service and traffic within the PIN, and so on. A PIN-user may request a public line mobile network (PLMN) to create a PIN that may only last for a short period of time, such as on the order of a few hours. For example, a PIN is set up to operate for two hours and is torn down. Devices may be connected to this PIN during its operation hours and will be disconnected after the operation hours expire.

3GPP SA1 also has started another study on providing on-demand localized services, which allows user equipments (UEs) to access a local network for certain hosted services for a short period of time. This local network can be an on-demand temporary private network, e.g., providing services for sport games and big entertainment events.

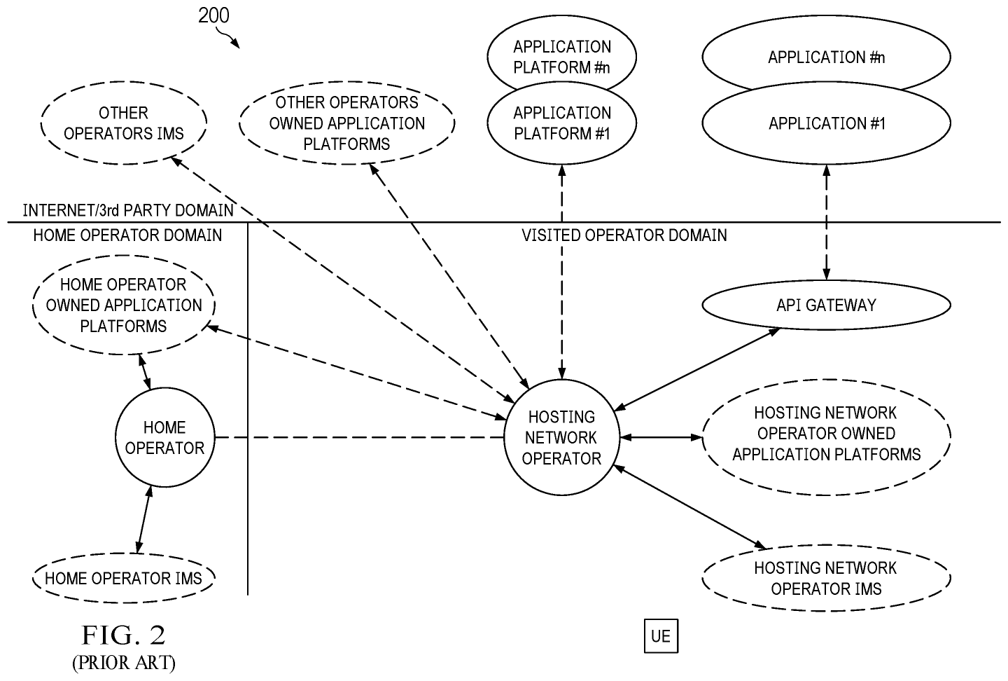

FIG. 2 illustrates a diagram of an example localized service system 200. FIG. 2 shows a hosting network operator owned/collaborative roaming scenario—local breakout, which is provided in 3GPP TS 22.844. According to 3GPP TS 22.844, the local breakout scenario is for both owned and collaborative scenarios between a visited hosting network operator and operators in 3rd party domains, where traffic is routed to an application from the hosting network to 1) hosting network owned application platforms, 2) collaborative home network owned application platforms, and 3) third parties via roaming agreements between visited hosting network operator and home/other network operators, and between hosting network operators and other application/service providers. Other network operators and application/service operators in the 3rd party domain provide collaborative services in application platform to the hosting network operator. The arrows with solid lines represent the traffic routed over trusted domains within the hosting network, and the arrows with dash lines represent the traffic routed over untrusted domain outside of the hosting operator network.

Based on these two studies and in view of the increasing demands for providing various wireless network communication services with increased capacities, it is desirable that a new type of on-demand private networks, which can be created very fast (e.g., within minutes), may only last for a short period of time and may be configured to support certain specific services (e.g., an on-demand network for an unplanned event, for social gathering, for fun activities, and so on), can be considered and supported by 3GPP standard. Mechanisms may also be needed for UEs to be able to quickly and automatically identify such networks, select and access the networks, and obtain local services from this type of networks. This new type of on-demand networks may be referred to as a “short-lived network”, a “temporary on-demand network”, or an “on-demand and short-lived network”, which may be used interchangeably in the present disclosure. The PINs and the on-demand local networks discussed above may all belong to this type of short-lived networks.

A short-lived network may have any one or more of the following characteristics:
The network is a small local network with limited coverage;
The network is tied to certain localized services, and only operates for certain time period;
The network is created dynamically based on demand and only lasts for a period of time. Services that UEs/users receive from this network may have time constraint (e.g., the UEs/users can only use for certain time or during a certain period);
UEs/Users who can access the network may be one time users, and do not have previous knowledge, subscription/business contract with this network. New authentication, authorization and protection mechanisms are needed for accessing the network.

Current 3GPP standardized PLMN and private networks, such as a public network integrated (PNI) non-public network (NPN) (or PNI_NPN), are typically statically deployed and are expected to last for a while (e.g., much longer than a few hours). Therefore, a UE does not consider the life span of such a network when it selects and accesses the network using the existing standardized mechanisms. Further, there is no mechanism for such a network to provide its life span information to a UE.

When a short-lived network is active, it is desirable for a UE to know the life span of the network and services it provides. With this information, the UE may be able to act accordingly when accessing the network for services, to avoid degraded user experience. As an example, the UE may move a service section to another network when the temporary on-demand network is approaching its end of operation. As another example, the UE may consider the life span of the network during network selection, e.g., the UE may not select the network that is approaching the end of its life).

Currently, only user subscription data (which defines a corresponding network configuration and policy (e.g., quality of service (QoS), service restriction, and so on) for a user who purchases a network service, as defined in TS23.501, V17.2.0, 2021-September) contains a service time restriction. The service time restriction restricts how long the user's subscription for the network service with a network is. That is, the service time restriction restricts how long the network service can be provided to the user based on the user's subscription with the network. However, this service time restriction is only applicable to the subscription of the network service provided by an operator, not to operations of a specific network or operations of a service of a network. Further, the service time restriction is only applicable to network services provided by a home operator of a UE, but not applicable to the network itself and other non-home networks, especially a new network which the UE has no prior knowledge about, such as an on-demand short-lived network. Furthermore, because this restriction is associated with the user's subscription, it's relatively static and not suitable for on-demand network. In addition, when the service time expires, the network terminates the service with the UE without giving an advance notification to the UE, which can cause a service disruption.

Embodiments of the present disclosure provide mechanisms that allow an on-demand and short-lived network to provide active service time information of the network to UEs who are interested in selecting and accessing this network, during different interaction phases (e.g., phases for network selection, network registration, session establishment, and so on) between the UEs and the network. The active service time information may be information related to operation time of the network and/or operation time of a service provided by this network, e.g., life span of the network or the service. A set of active service time information may be exchanged between the network and one or more UEs. The active service time information may be used by the network to configure network functions for connection services provided to UEs, as an example.

In some embodiments, the active service time information of an on-demand and short-lived network (referred to as “the network” in the following description for simplicity) may include one or more of following information:
an operation duration of the network, and/or an operation duration of one or more services offered by the network;
the remaining operation time of the network, and/or the remaining operation time of one or more services;
the operation starting time of the network, and/or the operation starting time of one or more services;
the operation ending time of the network, and/or the operation ending time of one or more services;
a notification of the end of the operation of the network, and/or a notification of the end of the operation of one or more services;
a counter number, which is reduced by a certain pre-defined number at a certain pre-defined interval; or other information that is related to the operation time (e.g., duration) of the network and/or a service.

The above time (e.g., staring time, ending time, operation time and duration) may be generally referred to as active service time of the network.

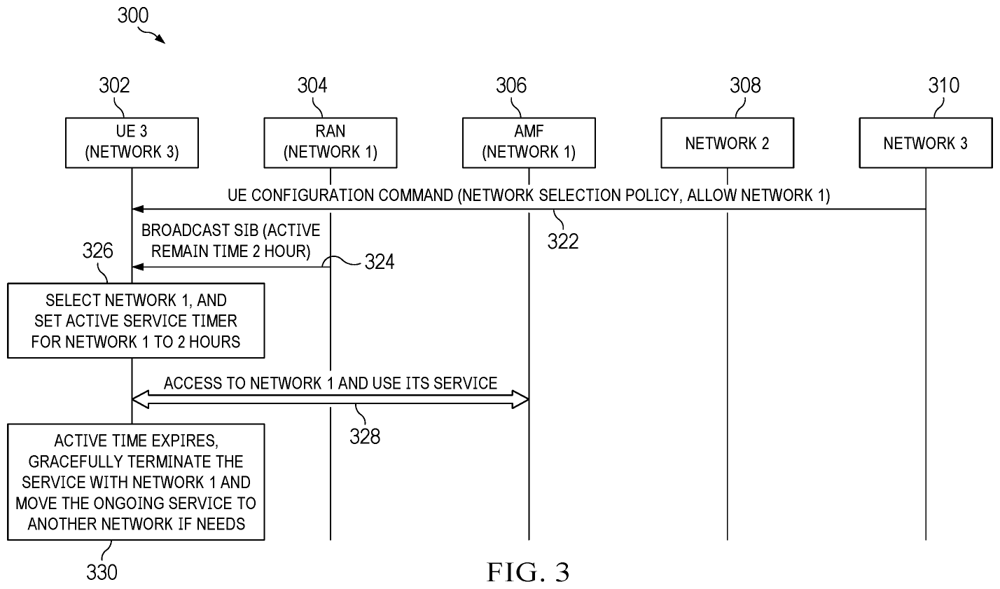

UEs or users, who are interested in accessing a short-lived network, which is set up for a short period of time and for a certain localized service, may obtain the active service time information of the network and/or a service of the network. In an embodiment, a UE may set a timer (or a counter) associated with the active service time information, which is associated with a network or a service provided by the network, and use the timer or counter to trigger the UE to gracefully terminate the service with this network or terminate accessing the network, without experiencing service disruption before the network (or service) operation ends. That is, the UE is able to start a termination procedure with the network earlier before the network operation ends, so as to have sufficient time to terminate a service/communication with the network. The UE may initiate a termination procedure, and sends a termination notification to the network. The value of the timer may be equal to or less than an active service time (e.g., an operation duration of a network or a service, or a remaining operation time of the network or the service provided by the network). As an example, the value of the timer may be set to be: active service time—constant. Before or when the timer expires, the UE may timely terminate its access to the network, and may determine whether or not to continue to receive the service from another network, as an example. The constant may be configured by the technical standard, a user, a UE, or the network. For example, the constant may be set to 10 minutes, which is used as an example in FIG. 3 described later in this disclosure. This timer may be defined in TS23.501 as one implementation option. This timer may also be provisioned to network functions by a network operation, administration and management (OAM) function or other network policy management functions (e.g., a policy control function (PCF)), e.g., when the network is establishing connection services for users/UEs. The network may monitor the remaining operation time while providing services to the UEs.

In some embodiments, the active service time information may be used by a UE as part of network selection criteria. In some embodiments, a new network selection policy and/or procedure, which is based on the network active service time, may be established. The new network selection policy may specify a condition (or requirement, criterion, restriction) for selecting a network by a UE, and the condition is related to the active service time of the network to be selected. For example, the condition may require that a UE may only select a network that has an active operation time longer than a threshold when the UE first identifies the network, and the UE follows the new network selection procedure for network selection. As another example, the condition may specify a minimum remaining operation time required for a network to be selected. As another example, the condition may specify a restriction on starting and ending time of a network to be selected. The new network selection policy may also specify whether a UE is allowed to access a type of short-lived network. An implementation of this embodiment may be adopted as an enhancement to the network selection policy and procedure defined by 3GPP specification TS23.122, V17.4.0, 2021-September, which is hereby incorporated herein by reference in its entirety. For example, the active service time of candidate networks may be taken into consideration in the network selection requirements.

The new network selection policy/procedure may be provisioned from the network to the UE and stored in the UE as part of a network selection policy configuration. The new network selection policy/procedure may also configured by a user of the UE, or configured by an authorized third party (e.g., by an application provider who steers a UE to a short-lived network) via a message such as a UE parameter update (UPU) message or a UE configuration update (UCU) message as defined by 3GPP TS 23.501, an application level message, or other applicable message such as a control message for network selection configuration.

In some embodiments, a new UE subscription data may be defined in TS 23.501, which may include a restriction/policy of allowing an active duration for a certain service when the service is associated with a certain network. The new UE subscription data may be defined as a subscription policy, which may be known to the network and the UE associated with this subscription.

In some embodiments, the active service time information of a short-lived network may be broadcast to UEs. The active service time information may include any one or more of the information as described above. In some embodiment, the active service time information of a short-lived network may be broadcast (e.g., using system information block (SIB) messages) by the short-lived network, e.g., by a radio access network (RAN) of the short-lived network, and received by UEs. As an example, the RAN may periodically broadcast the active service time information of the short-lived network via a SIB message. As another example, the RAN may periodically broadcast, via a SIB message, a service type or a service ID of each of one or more services that are supported by the short-lived network, and broadcast the active service time information associated with the service type or service ID as well.

In some embodiments, a UE may receive the broadcasted active service time information of the short-lived network, and determines the remaining operation time (also referred to as remaining active service time, or remaining operation duration) of the network and/or a service that the network provides. In an example, the broadcasted active service time information may include or indicate directly the remaining operation time of the network and/or service, which can be obtained by the UE from the broadcasted active service time information. In another example, the UE may determine (e.g., calculate) the remaining operation time of the network and/or service based on the broadcasted active service time information and the current time. For example, the active service time information indicates an operation duration of the network is from 6 am to 4 pm, and the UE may determine the remaining operation time of the network based on the current time.

The UE may use the remaining active service time information as part of input for network selection, if the network selection policy requires consideration of the active service time of the network. For example, when the remaining active service time of the network satisfies a condition required by the network selection policy, the UE may determine to select the network and registers with the network. After the UE has successfully registered to the network, the UE may continue to monitor the periodic SIB for the active service time information of the network or a service of the network, to monitor and to be updated with the ending time of operation of the network or the service.

Considering the limited resources of a RAN for sending a SIB, broadcasting the active service time information using the SIB may be optional. In some embodiments, a short-lived network may provide its active service time information to a UE individually. As examples, the network may send the active service time information to a UE during a procedure for network registration, service request, service modification or service termination of the UE with the network, or during a procedure for packet data unit (PDU) session establishment, PDU session modification or PDU session termination with the network.

In this case, there may be two levels of active service time information: a network level and a service (e.g., a PDU session) level. That is, the active service time information may be configured per network or per service (per PDU session), and conveyed to UEs. For a short-lived network to provide the active service time information at the network level, the following four embodiment options may be used.

Option 1

A network function of the network, such as an access management function (AMF), may include the active service time information of the network in the “registration accept” control message as defined in 3GPP TS 23.501, and send the control message to a UE after the UE has been authenticated and authorized for accessing the network. The active service time information may be added in the “registration accept” control message and delivered to the UE using the “registration accept” control message during the initial network service registration procedure of the UE with the network, or during a periodic registration update procedure of the UE with the network with network re-entry occurring after the UE transitions from an idle state to an active state. During these procedures, network functions that are involved may also be provisioned with the active service time information, and a network function may configure a corresponding network service for a UE according to the active service time. For example, a network function may set an active service timer for the UE according to the remaining active service time of the network after these procedure are successfully completed.

The UE may also request, from the network, the active service time of the network, by adding an active service time request indication in the registration request message to the AMF (as defined in TS23.501), as an example. The network may then send the registration accept message to the UE, carrying the active service time of the network.

Option 2

A network function, such as the AMF, may initiate a UE configuration update procedure to the UE to update the network active service time information, via the “UE configuration command” control message (as defined in TS 23.501), if the network active service time has changed (e.g., extended or reduced); or may notify the UE for upcoming termination of operation of the network using the “UE configuration command” control message, which carries the remaining operation time information of the network. The network function may also be updated with a new active service time.

Option 3

When a short-lived network is approaching to the end of its life span, it may initiate a network-initiated deregistration procedure, and send, to a UE, a “de-registration request” control message (as defined in TS 23.501) including the remaining active time information. After receiving the de-registration request control message from the network, the UE may prepare for transition of still active service(s) (e.g., move a service to another network), and start a UE-initiated network de-registration before the network life span expires.

Option 4

A short-lived network may use other suitable messages and network functions, such as a handover control message, or an access stratum or non-access stratum (AS/NAS) message to provide the active service time information to a UE.

For a short-lived network to provide the active service time information at the application/service (e.g., a PDU session) level to a UE, the following three embodiment options may be used. Each service that the UE receives from the network (e.g., each PDU session or each access point name (APN) can have its own active service time).

Option 1

During the initial PDU session establishment phase, a network function (e.g., an AMF, a session management function (SMF), and so on) may add and include active service time information of a PDU session in the “PDU establishment Accept” control message (as defined in TS 23.501), and send the PDU establishment accept message to the UE. During the initial PDU session establishment procedure, network functions that are involved may also be provisioned with the active service time information, and a network function may configure a corresponding network service for the UE according to the active service time. For example, the network function may set an active service timer for the PDU session with the remaining active service time after the initial PDU session establishment procedure is successfully completed.

The UE may also request, from the network, the active service time, e.g., by adding an active serviced time request indication in the PDU session establishment request message (as defined in TS 23.501), and send the message to the network.

Option 2

A network function, such as the AMF and the SMF, may interact with a UE to conduct a PDU session modification to modify the active service time of a PDU session, e.g., by adding the active service time information in a “PDU session modification request” control message (as defined in TS 23.501), if the active service time has been changed. As an example, the active service time information may include the latest remaining operation duration of the network, or a new service ending time of the network if it has been changed.

Option 3

The active service time for a PDU session may be delivered to a UE using other control messages (such as a policy update message, a UE routing selection policy message, and so on) (as defined in TS 23.501) between the UE and the network.

In some embodiments, a UE may set a timer that is associated with the active service time information of a short-lived network for a PDU session between the UE and the network. The timer may be used to trigger the UE to gracefully terminate the PDU session with the network, or move (e.g., handover) the PDU session to another network without service disruption, before the PDU session operation is terminated. For example, the UE may handover from the short-lived network to another network to continue the PDU session/service. This another network may be another short-lived network or a non-short-lived network. In another example, the UE may handover the PDU session at the application level, e.g., the UE may switch to an application that supports continuing the PDU session via a different IP link while the UE still stay with the same short-lived network. The timer may be set to be equal to or less than the remaining active service time of the PDU session. A new timer may be defined in TS 23.501 for session management of clause 5.6. This new timer may also be provisioned to one or more network functions by the network OAM or other network policy management functions (e.g., the PCF) when the network is establishing the PDU session for the UE.

A UE may determine whether to select a short-lived network based on the active service time of the network and a network selection policy of the UE. When determining to select the network, the UE may register with the network, start accessing the network receiving service(s) from the network. A timer may be set based on the active service time of the network. The short-lived network may update its active service time during the UE's access to the network, and in this case, the UE may update the timer accordingly. The UE may also request the network to extend an operation time during its access to the network, and if the request is granted, the UE may update the timer accordingly. When the timer expires, the UE may terminate accessing the network, or access another network to continue a service. For example, the UE may search, before the timer expires, for candidate networks for receiving the service continuously based on the network selection policy and active service time of the candidate networks. The UE may receive a notification from the network, notifying the UE of termination or end of the operation of the network or service.

FIG. 3 is a flow diagram 300 illustrating embodiment interactions between a UE and networks, highlighting broadcast of the active service time information of a short-lived network and network selection based on the active service time information. In this example, a network 1 is a short-lived and on-demand network (e.g., the network 1 may be a hotspot which only operates from loam-5 pm or only operates for 5 hours in a theater or a concert; or the game party PIN in the use case illustrated in Annex B). A UE 3 302 has service subscription to a network 2 308 and has service subscription to a network 3 30. The UE 3 302 may be a guest device of the network 1, such as a device of User 1 or User 2 in the use case of Annex B.

As shown, the network 3 310 may provide a network selection policy to its subscribers (UEs, including UE 3 302), e.g., via a UE configuration command (step 322). The network selection policy may include a condition/requirement for selecting a network by a UE based on active service time of the network, as described above. In this example, the network section policy does not include restriction on remaining operation time of a network to be considered by the UE for network selection.

The network 1 (using RAN 304) may broadcasts its remaining active service time (e.g., 2 hours in this example) in a SIB (step 324). The remaining active service time is the active service time information of the network 1. The UE 3 302 in the coverage of the network 1 may receive the broadcast SIB. The UE 3 302 may then determine whether to select the network 1 based on its network selection policy and the remaining active service time of the network 1. The network selection policy of the UE 3 302 does not restrict on the remaining operation time of a network, and thus, the network 1 satisfies the network selection policy. The UE 3 302 may select the network 1, register to the network 1, and set an active service timer to 2 hours for accessing the network 1 (step 326). The active service timer may be shorter than the broadcast remaining active service time of the network 1, so as to give sufficient time for graceful termination of accessing the network 1 on the UE side. The UE 3 302 may then access the network 1 (via AMF 306 of the network 1) for one or more services provided by the network 1 (step 328).

When or before the active service timer expires, the UE 3 302 may gracefully terminate its service(s) with the network 1, and as an example, may optionally move a service session (an ongoing service) to another network if available (step 330). For example, before the active service timer expires, the UE 3 302 may search for other networks that are available for providing the service, select one network as a candidate (e.g., similarly to selecting the network 1), and move the service session from the network 1 to the candidate. The UE 3 302 thus can receive the service without interruption. The network 1 may also send, to the UE 3 302, a notification notifying that the network operation will end, or the network 1 will terminate the service provided to the UE. In general, either the UE or the network 1 can send a termination notification/message to the other party to initiate a termination procedure.

In an embodiment, the active service time information broadcast by the network 1 may also include information of a counter number reduced by a certain pre-defined number at a certain pre-defined interval. For example, the network 1 may broadcast a counter number 12, which decreases by 1 (i.e., the pre-defined number) per 10 min (i.e., the pre-defined interval). The UE may utilize this counter number to track the remaining operation time of the network 1, so that when the counter number reaches 0 (i.e., the 2 hours remaining operation time of the network 1 expires), the operation of the network 1 ends. The broadcast of this information also serve informing the UE of the manner that the network 1 monitors its remaining operation time.

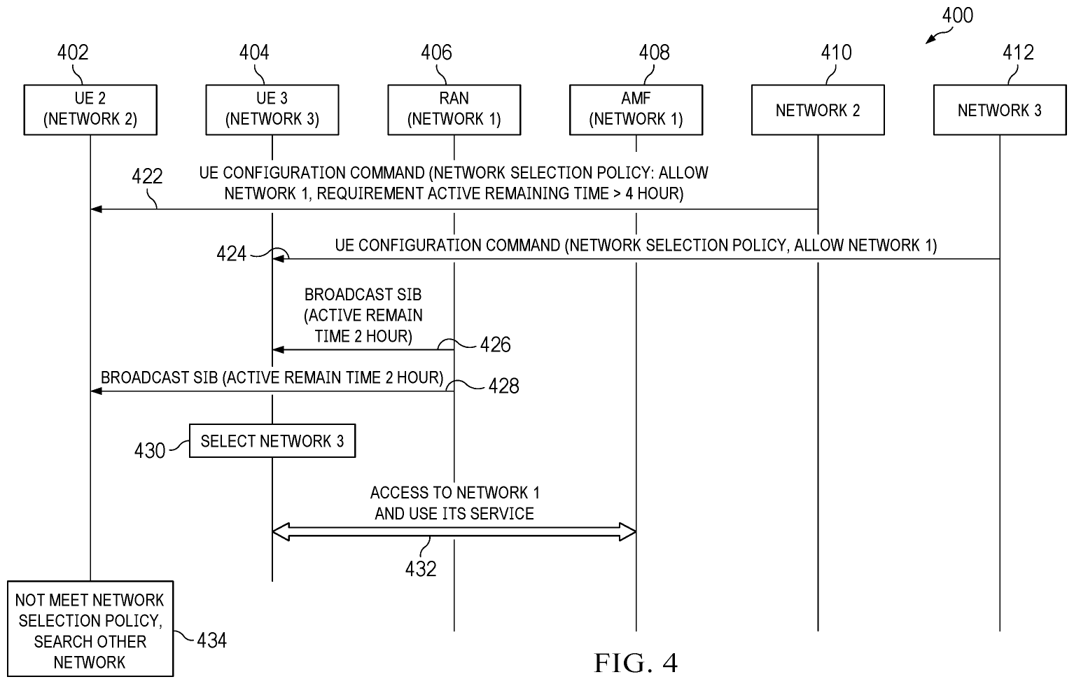

FIG. 4 is a flow diagram 400 illustrating embodiment interactions between UEs and networks, highlighting broadcast of the active service time information of a short-lived network and network selection based on the active service time information. In this example, network 1 is a short-lived and on-demand network (e.g., network 1 may be a hotspot which only operates from loam-5 pm or only operates for 5 hours in a theater or a concert; or the game party PIN in the use case illustrated in Annex B). A UE 2 402 has service subscription to a network 2 410, and a UE 3 404 has service subscription to a network 3 412. As an example, the UE 2 402 and the UE 3 404 may be guest devices, such as devices of User 1 and User 2 in the use case of Annex B, respectively.

As shown, the network 2 410 may provide a network selection policy to its UEs (e.g., the UE 2 402) using a UE configuration command message (step 422). The network selection policy may include a condition/requirement of only allowing the UE 2 402 to automatically select a visited network whose remaining operation time >4 hours (i.e., the UE can only select a network to access if the network has a remaining operation time greater than 4 hours), as an example.

The network 3 412 may provide a network selection policy to its UEs (e.g., the UE 3 404) using a UE configuration command message (step 424). In this example, the network selection policy does not include restriction on the remaining operation time of a visited network.

The network 1 (RAN 406 of the network 1) may broadcast its remaining active time (2 hours in this example) in a SIB (steps 426, 428). The UE 2 402 and UE 3 404 in the coverage of the network 1 may receive the broadcast remaining active time of the network 1.

The network 1 satisfies the network selection policy of the UE 3 404 (which does not restrict on the remaining active time of a visited network), the UE 3 404 may select and register to the network 1 (step 430). The UE 3 302 may then access the network 1 (via AMF 408 of the network 1) for one or more services provided by the network 1 (step 432).

The remaining operation time of the network 1 doesn't satisfy the network selection policy of the UE 2 402, and the UE 2 402 may search for other networks (step 434). The network selection policy of the UE 2 402 requires a remaining operation time greater than 4 hours, while the network 1 has a remaining operation time of 2 hours, i.e., 2 hour<4 hour selection threshold. Thus, the network 1 does not satisfy the network selection policy of UE 2 402, and the UE 2 402 does not select the network 1, and may continue to search and select other suitable networks.

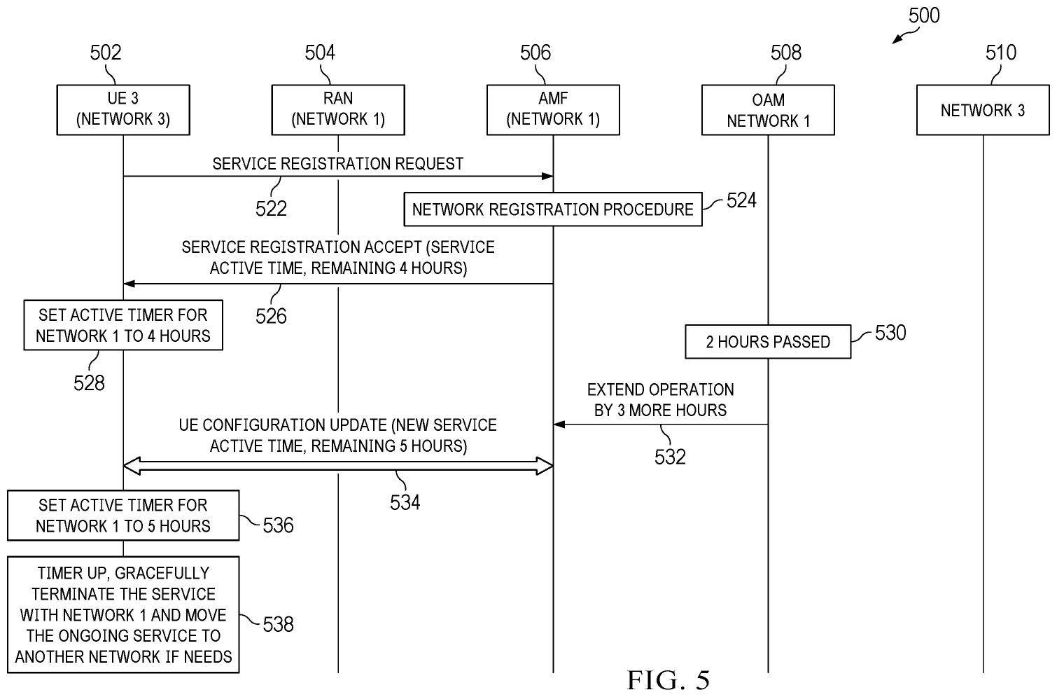

FIG. 5 is a flow diagram 500 illustrating embodiment interactions between a UE and networks, highlighting individual transmission of the active service time information of a short-lived network. In this example, a network 1 is a short-lived and on-demand network (e.g., the network 1 may be a hotspot which only operates from loam-5 pm or only operates for 5 hours in a theater or a concert; or the game party PIN in the use case illustrated in Annex B). A UE 3 502 has service subscription to a network 3 510. The UE 2 512 and UE 3 502 may be guest devices of the network 1, such as devices of User 1 and User 2 in the use case of Annex B. The network 1 may have business relationship with the network 3 510 and allow subscriber UEs of the network 3 510 to access the network 1.

The UE 3 502 (having subscription of the network 3 510) may register to the network 1 (via an AMF 506 of the network 1) (step 522). As an example, the network 1 may be selected by the UE 3 502 based on its network selection policy and the active service time information of the network 1, as illustrate with respect to FIG. 3. The UE 3 502 may send a registration request to the network 1 for registration with the network 1, and the network 1 (the AMF 506) may perform a registration procedure for the UE 3 502 (step 524), as described in the registration procedure of TS 23.502, which is incorporated herein by reference.

The AMF 506 may send a registration accept message to the UE 3 502, where the registration accept message may include a remaining operation time of the network 1, e.g., 4 hours in this example (step 526). The UE 3 502 may set an active service timer to 4 hours for the network 1 (step 528). The active service timer may be shorter than the remaining operation time of the network 1, so that the UE 3 502 may terminate accessing the network timely before the end of the network 1's operation. The UE 3 502 may then access the network 1 for service(s) provided by the network 1.

The network 1 may extend its operation time. As an example, after 2 hours passes (step 530), the network 1 (e.g., by OAM of the network 1) may decide to extend its operation by additional 3 hours (step 532). In this case, the AMF 506 of network 1 may initiate a UE configuration update procedure to update its extended remaining active time with the UE 3 502. For example, the OAM 508 may send a UE configuration update message to the UE 3 502, including new active service time information, i.e., the updated remaining operation time (5 hours) in this example (step 534). Upon receipt of the UE configuration update message, the UE 3 502 may update its active service timer to 5 hours or shorter (step 536). When or before active service timer expires, the UE 3 502 may gracefully terminate its service with the network 1, and optionally move an ongoing service (e.g., a service session, a PDU session) to another network if available.

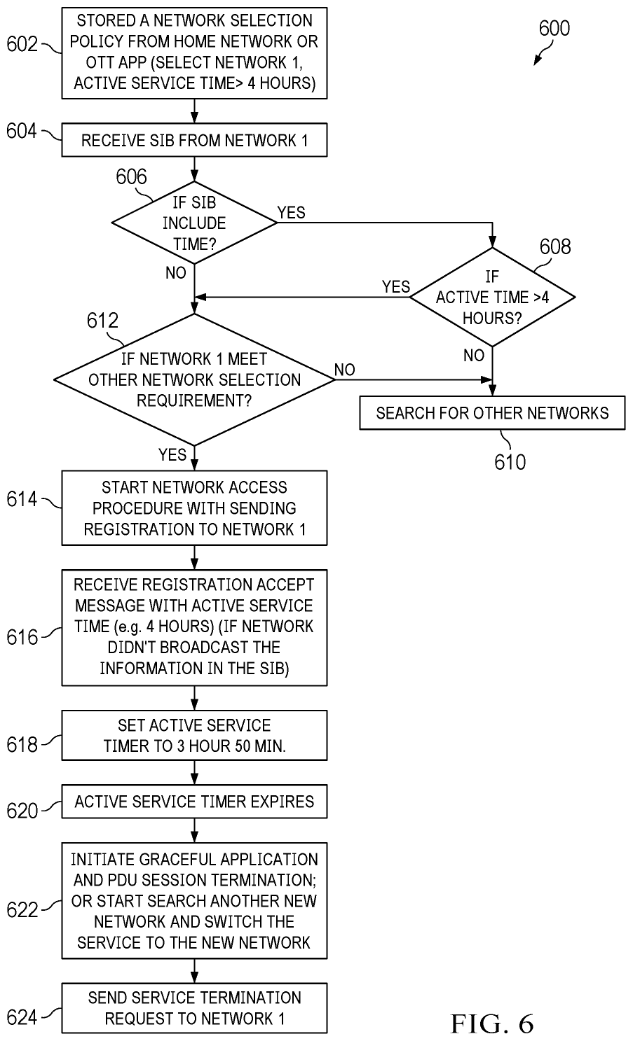

FIG. 6 illustrates a diagram 600 of UE operations, highlighting the use of the active service time by a UE. As shown, the UE may store a network selection policy obtained from a home network of the UE, or obtained from an over the top (OTT) application (block 602). The network selection policy may require that a visited network needs to have an active service time greater than 4 hours. The active service time may be an operation duration of the visited network (or a service provided by the visited network), or the remaining operation time of the visited network (or a service). The network selection policy may include other requirements related to operation time of a visited network, as discussed above. The UE may receive a SIB from a network 1 (block 604). The network 1 is a short-lived and on-demand network, e.g., the network 1 may be a hotspot which only operates from loam-5 pm or only operates for 5 hours in a theater or a concert; or the game party PIN in the use case illustrated in Annex B.

The UE may determine whether the SIB includes active service time information of the network 1 (block 606). If the SIB includes the active service time information of the network 1, the UE may determine whether an active service time of the network 1 satisfies its network selection policy, i.e., whether the active service time of the network 1 is greater than 4 hours (block 608). The network 1 may broadcast its active service time periodically. When the active service time of the network 1 is not greater than 4 hours, the UE may search for other networks (block 610). The UE may be configured to prefer to select a network that satisfies its network selection policy.

The UE may proceed to block 612 to check whether the network 1 meets other network selection requirement(s) (block 612), when the SIB does not include the active service time information of the network 1, or when the active service time of the network 1 is greater than 4 hours. The network selection requirement(s) may include any requirement used in the existing or future network selection mechanisms. For example, the UE may check whether signal strength of the network 1 exceeds a threshold, whether signal quality of the network 1 exceeds a threshold, and/or whether the network 1 is in a list of preferred networks configured for the UE. When the network 1 does not meet the other network selection requirement(s) (block 612), the UE may proceed to block 610 to search for other networks that satisfy its network selection policy.

When the network 1 meets the other network selection requirement, the UE may start a network access procedure for accessing the network 1, for example, the UE may send a registration request to the network 1 (block 614). The UE may then receive a registration accept message from the network 1 in response to sending the registration request (step 616). If the network 1 does not broadcast the active service time of the network in the SIB, the registration accept message may include the active service time (remaining operation time in this example, which is 4 hours) of the network 1. The UE may set an active service timer to 3 hours 50 minutes (block 618). The UE may access the network 1 and receive one or more services from the network 1. When the active service timer expires (block 620), the UE may initiate a graceful application and PDU session termination with the network 1, or start searching for another network and switch a service with the network to the new network (step 622). The UE may search for another network before the active service timer expires, so that the UE may continue to receive a service from a new network.

The embodiments above use the remaining active operation (service) time of a short-lived network merely for illustrative purposes. The short-lived network may transmit various active service time information, individually or in combination, as described previously. The active service time information transmitted may indicate, directly or indirectly, an expiration time of operation of the network or a service provided by the network. The active service time information transmitted may be per service type, or UE type, service priority, or UE priority, and/or any other applicable characteristics.

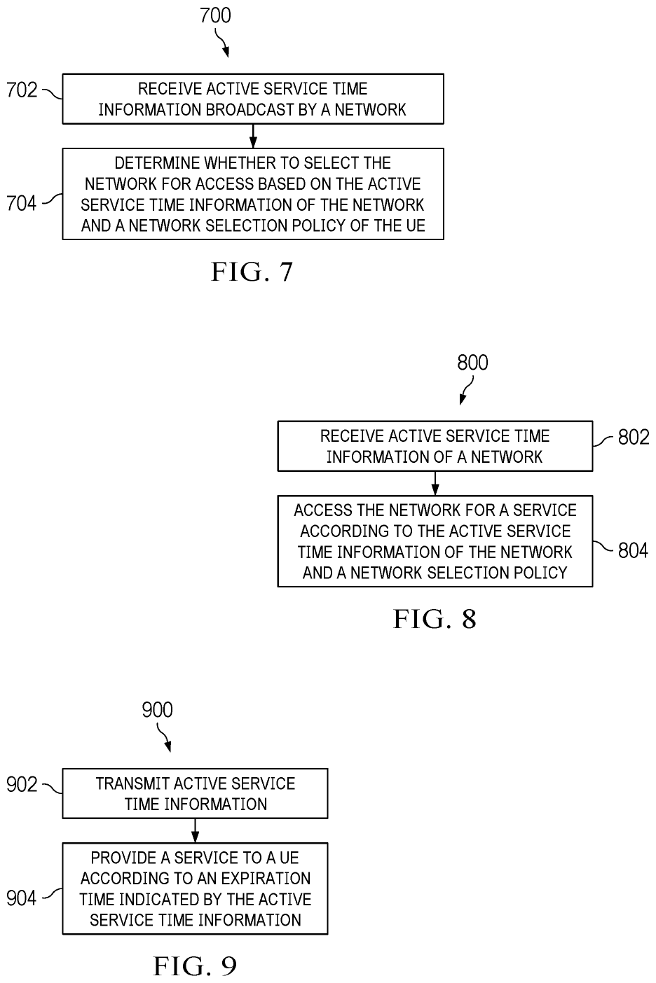

FIG. 7 is a flow diagram 700 of embodiment UE operations, highlighting network selection based on active service time. As shown, a UE may receive active service time information broadcast by a network (block 702). The active service time information of the network indicates an expiration time of operation of the network or a service provided by the network. The network may be a short-lived network that is created on-demand and lasts for a short period of time, e.g., 8 hours. The network may have a business relationship with a home network of the UE. The UE has subscription to its home network, and may travel to the coverage area of the network. The UE may determine whether to select the network for access based on the active service time information of the network and a network selection policy of the UE (block 704). The network selection policy may include information indicating one or more requirements that are based on network active service time.

FIG. 8 is a flow diagram Boo of embodiment UE operations, highlighting network access based on active service time. As shown, a UE may receive active service time information of a network (block 802). The active service time information of the network indicates an expiration time of operation of the network or a service provided by the network. The network may be a short-lived network that is created on-demand and lasts for a short period of time, e.g., 4 hours. The network may have a business relationship with a home network of the UE. The UE has subscription to its home network, and may travel to the coverage area of the network. The UE may access the network for a service according to the active service time information of the network and a network selection policy (block 804). The network selection policy comprising information indicating one or more requirements that are based on network active service time.

FIG. 9 illustrates a flow diagram 900 of an embodiment network operation. A network may transmit active service time information of the network (block 902). The network may be a short-lived network that is created on-demand and lasts for a short period of time. The active service time information may indicate an expiration time of operation of the network or a service provided by the network. The active service time information enables one or more user equipments (UEs) in the coverage of the network to determine whether to access the network for one or more services provided by the network. The network may start a registration procedure to register the UE with the network when the UE selects the network. The network provides a service to a UE according to the expiration time indicated by the active service time information (block 904).

FIG. 10 is a diagram of an example communication system 1000. In general, the system woo enables multiple wireless or wired users to transmit and receive data and other content. The system woo may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system woo includes electronic devices (ED) 1010a-1010c, radio access networks (RANs) 1020a-1020b, a core network 1030, a public switched telephone network (PSTN) 1040, the Internet 1050, and other networks 1060. While certain numbers of these components or elements are shown in FIG. 10, any number of these components or elements may be included in the system 1000.

The EDs 1010a-1010c are configured to operate or communicate in the system 1000. For example, the EDs Iowa-borne are configured to transmit or receive via wireless or wired communication channels. Each ED 1010a-1010c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1020a-1020b here include base stations 1070a-1070b, respectively. Each base station 1070a-1070b is configured to wirelessly interface with one or more of the EDs 1010a-1010c to enable access to the core network 1030, the PSTN 1040, the Internet 1050, or the other networks 1060. For example, the base stations 1070a-1070b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (AP), or a wireless router. The EDs 1010a-1010c are configured to interface and communicate with the Internet 105o and may access the core network 1030, the PSTN 1040, or the other networks 1060.

In the embodiment shown in FIG. 10, the base station 1070a forms part of the RAN 1020a, which may include other base stations, elements, or devices. Also, the base station 1070b forms part of the RAN 1020b, which may include other base stations, elements, or devices. Each base station 1070a-1070b operates to transmit or receive wireless signals within a particular geographic region or area, sometimes referred to as a “cell.” In some embodiments, multiple-input multiple-output (MIMO) technology may be employed having multiple transceivers for each cell.

The base stations 1070a-1070b communicate with one or more of the EDs Iowa-borne over one or more air interfaces 1090 using wireless communication links. The air interfaces 1090 may utilize any suitable radio access technology.

It is contemplated that the system woo may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1020a-1020b are in communication with the core network 1030 to provide the EDs 1010a-1010c with voice, data, application, Voice over Internet Protocol (VoIP), or other services. Understandably, the RANs 1020a-1020b or the core network 103o may be in direct or indirect communication with one or more other RANs (not shown). The core network 103o may also serve as a gateway access for other networks (such as the PSTN 1040, the Internet 1050, and the other networks 1060). In addition, some or all of the EDs 1010a-1010c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1050.

Although FIG. 10 illustrates one example of a communication system, various changes may be made to FIG. 10. For example, the communication system woo could include any number of EDs, base stations, networks, or other components in any suitable configuration.

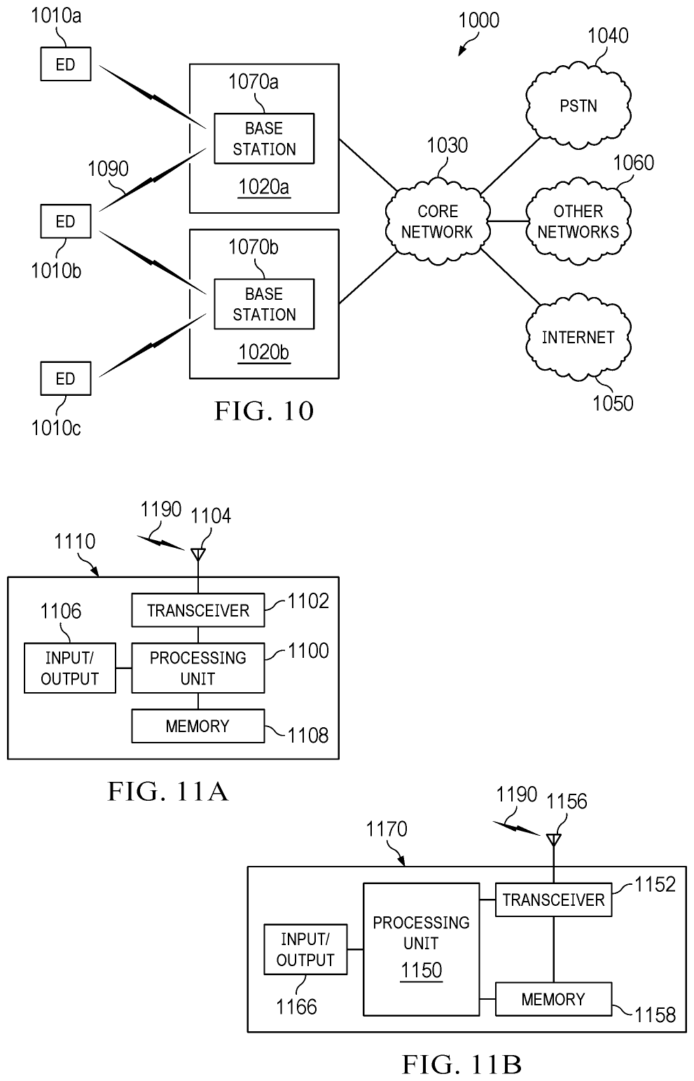

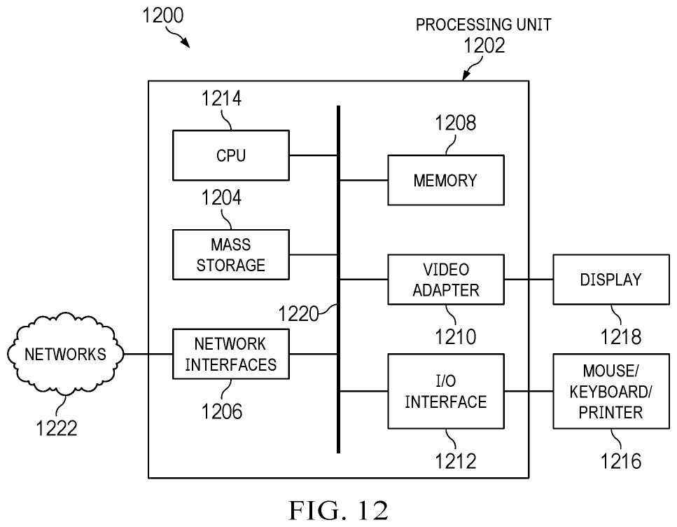

FIG. 11A and FIG. 11B are example devices that may implement the methods and teachings according to this disclosure. In particular, FIG. 11A illustrates an example ED 1110, and FIG. 11B illustrates an example base station 1170. These components could be used in the system woo or in any other suitable system.

As shown in FIG. 11A, the ED 1110 includes at least one processing unit 1100. The processing unit 1100 implements various processing operations of the ED 1110. For example, the processing unit 1100 could perform signal coding, data processing, power control, input/output processing, or any other functionality enabling the ED 1110 to operate in the system 1000. The processing unit 1100 also supports the methods and teachings described in more detail above. Each processing unit 1100 includes any suitable processing or computing device configured to perform one or more operations. Each processing unit 1100 could, for example, include a microprocessor, microcontroller, digital signal processor, field programmable gate array, or application specific integrated circuit.

The ED 1110 also includes at least one transceiver 1102. The transceiver 1102 is configured to modulate data or other content for transmission by at least one antenna or NIC (network interface controller) 1104. The transceiver 1102 is also configured to demodulate data or other content received by the at least one antenna 1104. Each transceiver 1102 includes any suitable structure for generating signals for wireless or wired transmission or processing signals received wirelessly or by wire. Each antenna 1104 includes any suitable structure for transmitting or receiving wireless or wired signals 1190. One or multiple transceivers 1102 could be used in the ED 1110, and one or multiple antennas 1104 could be used in the ED 1110. Although shown as a single functional unit, a transceiver 1102 could also be implemented using at least one transmitter and at least one separate receiver.

The ED 1110 further includes one or more input/output devices 1106 or interfaces (such as a wired interface to the Internet 1050). The input/output devices 1106 facilitate interaction with a user or other devices (network communications) in the network. Each input/output device 1106 includes any suitable structure for providing information to or receiving information from a user, such as a speaker, microphone, keypad, keyboard, display, or touch screen, including network interface communications.

In addition, the ED 1110 includes at least one memory 1108. The memory 1108 stores instructions and data used, generated, or collected by the ED 1110. For example, the memory 1108 could store software or firmware instructions executed by the processing unit(s) 1100 and data used to reduce or eliminate interference in incoming signals. Each memory 1108 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 11B, the base station 117o includes at least one processing unit 1150, at least one transceiver 1152, which includes functionality for a transmitter and a receiver, one or more antennas 1156, at least one memory 1158, and one or more input/output devices or interfaces 1166. A scheduler, which would be understood by one skilled in the aft, is coupled to the processing unit 1150. The scheduler could be included within or operated separately from the base station 1170. The processing unit 1150 implements various processing operations of the base station 1170, such as signal coding, data processing, power control, input/output processing, or any other functionality. The processing unit 1150 can also support the methods and teachings described in more detail above. Each processing unit 1150 includes any suitable processing or computing device configured to perform one or more operations. Each processing unit 1150 could, for example, include a microprocessor, microcontroller, digital signal processor, field programmable gate array, or application specific integrated circuit.

Each transceiver 1152 includes any suitable structure for generating signals for wireless or wired transmission to one or more EDs or other devices. Each transceiver 1152 further includes any suitable structure for processing signals received wirelessly or by wire from one or more EDs or other devices. Although shown combined as a transceiver 1152, a transmitter and a receiver could be separate components. Each antenna 1156 includes any suitable structure for transmitting or receiving wireless or wired signals 1190. While a common antenna 1156 is shown here as being coupled to the transceiver 1152, one or more antennas 1156 could be coupled to the transceiver(s) 1152, allowing separate antennas 1156 to be coupled to the transmitter and the receiver if equipped as separate components. Each memory 1158 includes any suitable volatile or non-volatile storage and retrieval device(s). Each input/output device 1166 facilitates interaction with a user or other devices (network communications) in the network. Each input/output device 1166 includes any suitable structure for providing information to or receiving/providing information from a user, including network interface communications.

FIG. 12 is a block diagram of a computing system 1200 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1200 includes a processing unit 1202. The processing unit includes a central processing unit (CPU) 1214, memory 1208, and may further include a mass storage device 1204, a video adapter 1210, and an I/O interface 1212 connected to a bus 1220.

The bus 1220 may be one or more of any type of several bus architectures including a memory bus or memory controller, a peripheral bus, or a video bus. The CPU 1214 may comprise any type of electronic data processor. The memory 1208 may comprise any type of non-transitory system memory such as static random access memory (SRAM), dynamic random access memory (DRAM), synchronous DRAM (SDRAM), read-only memory (ROM), or a combination thereof. In an embodiment, the memory 1208 may include ROM for use at boot-up, and DRAM for program and data storage for use while executing programs.

The mass storage 1204 may comprise any type of non-transitory storage device configured to store data, programs, and other information and to make the data, programs, and other information accessible via the bus 1220. The mass storage 1204 may comprise, for example, one or more of a solid state drive, hard disk drive, a magnetic disk drive, or an optical disk drive.

The video adapter 1210 and the I/O interface 1212 provide interfaces to couple external input and output devices to the processing unit 1202. As illustrated, examples of input and output devices include a display 1218 coupled to the video adapter 1210 and a mouse, keyboard, or printer 1216 coupled to the I/O interface 1212. Other devices may be coupled to the processing unit 1202, and additional or fewer interface cards may be utilized. For example, a serial interface such as Universal Serial Bus (USB) (not shown) may be used to provide an interface for an external device.

The processing unit 1202 also includes one or more network interfaces 1206, which may comprise wired links, such as an Ethernet cable, or wireless links to access nodes or different networks. The network interfaces 1206 allow the processing unit 1202 to communicate with remote units via the networks. For example, the network interfaces 1206 may provide wireless communication via one or more transmitters/transmit antennas and one or more receivers/receive antennas. In an embodiment, the processing unit 1202 is coupled to a local-area network 1222 or a wide-area network for data processing and communications with remote devices, such as other processing units, the Internet, or remote storage facilities.

In some embodiments, the computing system 1200 may comprise an apparatus configured to implement the embodiments of the present disclosure. The memory 1208 may store instructions that are executable by the processing unit 1202. In an embodiment, the processing unit 1202 may execute the instructions to: receive active service time information of a first network that is broadcast by the first network, where the active service time information indicates an expiration time of operation of the first network or a service provided by the first network; and determine whether to select the first network for access based on the active service time information and a network selection policy. The network selection policy comprises information indicating one or more requirements that are based on network active service time.

In another embodiment, the processing unit 1202 may execute the instructions to: receive active service time information of a first network, where the active service time information indicates an expiration time of operation of the first network or a service provided by the first network; and access the first network for a first service according to the active service time information and a network selection policy. The network selection policy comprises information indicating one or more requirements that are based on network active service time.

In another embodiment, the processing unit 1202 may execute the instructions to: transmit active service time information indicating an expiration time of operation of the first network or a service provided by the first network, where the active service time information enables one or more user equipments (UEs) to determine whether to access the first network for one or more services provided by the first network; and provide a first service to a first UE according to the expiration time.

Embodiments of the present disclosure may be implemented in one or a combination of hardware, firmware and software. The embodiments may also be implemented as instructions stored on a non-transitory computer-readable storage device or media, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

It should be understood that software can be installed in and sold with an embodiment device/apparatus. Alternatively the software can be obtained and loaded into the embodiment device/apparatus, including obtaining the software through physical medium or distribution system, including, for example, from a server owned by the software creator or from a server not owned but used by the software creator. The software can be stored on a server for distribution over the Internet, for example.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a determining unit/module, a network selecting unit/module, a registration unit/module, an updating unit/module, a timing unit/module, a terminating unit/module, a requesting unit/module, a service continuing unit/module, a triggering unit/module, and/or a network accessing unit/module. The respective units/modules may be hardware, software, or a combination thereof. For instance, one or more of the units/modules may be an integrated circuit, such as field programmable gate arrays (FPGAs) or application-specific integrated circuits (ASICs).

The following references are related to subject matter of the present application. Each of these references is incorporated herein by reference in its entirety:
3GPP TR 22.844, “3rd Generation Partnership Project; Technical Specification Group Services and System Aspects; Study on 5G Networks Providing Access to Localized Services; Stage 1 (Release 18),” V18.2.0 (2021-December);
3GPP TS 23.501, “System architecture for the 5G System (5G5),” V17.2.0, 2021-September;
OPPO, “Revised SID New WID on Study on Personal IoT Networks”, SP-200592, June 30-Jul. 3, 2020;
TS 23.122, “3rd Generation Partnership Project; Technical Specification Group Core Network and Terminals; Non-Access-Stratum (NAS) functions related to Mobile Station (MS) in idle mode (Release 17),” V17.4.0 (2021-September);
TS 23.502, “3rd Generation Partnership Project; Technical Specification Group Services and System Aspects; Procedures for the 5G System (5GS); Stage 2 (Release 17),” V17.2.1+(2021-October).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

### Annex A: SA1 Study Item PIN (Personal IoT Network)

This study item was proposed by OPPO with approved SID: SP-200592 “Revised SID New WID on Study on Personal IoT Networks”, on June 30-Jul. 3, 2020.

Users create Personal IoT networks out of all of these Personal IoT devices mainly in their homes or around their body. These Personal IoT devices can use a multitude of different non 3GPP based wireless technologies to communicate within the Personal IoT network to allow a user to interact with and control.

Current 5G direct device connection standards are not optimized for short range communication (e.g., order of less than 1 m for wearables on a person's body to 40 m for home automation line of sight). Furthermore, 5G standards do not support consumer based private networks (e.g., home hub, CPE) where a user, in conjunction with an operator (PLMN) can easily manage consumer IoT devices that use 3GPP connection technologies.

The objectives of the SI include:
Study use cases related to 5GS support of Personal IoT networks and potential new requirements, e.g.,
   Interactions between devices in a Personal IoT network and devices in the cellular network.
   Interactions between devices in a Personal IoT network.
   Onboarding devices with operator managed credentials within the Personal IoT Network from a user/UE (e.g., smartphone) or via a 5G network (e.g. PLMN).
   Requirements and KPIs to improve performance of short-range direct device connections.
   Position requirements and KPIs (e.g., for 6 Degrees of Freedom [6DoF] etc.).

### Annex B: Use Case

Dynamic creation of an on-demand PIN at home
Description
Nowadays, most of the operators and smartphones provide a personal hotspot service, which allows the phone to become a WLAN hotspot that provides internet connections to other devices via the UE's mobile connections. But this only provides internet connectivity to those devices while the smartphone only acts as connection gateway. With the deployment of PIN and the support of the Mobile operators to use this as a new added value service, authorized mobile devices, such as smartphones, tablets, CPEs can be also used as a PIN gateway to dynamically create and manage an on-demand temporary PIN. This on-demand PIN will not only provide connectivity to the devices in the proximity, but also provides more flexibility and authority to the PIN-user to manage the PIN, such as to decide which devices to be connected into this PIN; to manage the service and the traffic within the PIN, so on.
The PIN uses licensed spectrum as well as unlicensed spectrum, Therefore, the creation and management of this type of on-demand PIN requires the authorization and supervision from the PLMN that owns the license spectrum. The PLMN can offer this new on-demand PIN service in certain constrained locations for authorized users with authorized devices. Although the on-demand PIN is provided and controlled by the PLMN, the authorized user of the on-demand PIN can have certain flexibility to manage this PIN, such as to decide when to create and terminate the PIN, coordinate with PLMN to authorize the devices to be allowed to access this PIN, manage the services being allowed in this PIN, so on.
Pre-conditions
Tom has a 5G home access router with a 5G subscription of operator M including additional subscription for on-demand PIN capability using mmWave spectrum 26 Ghz owned by M. The 5G home access router is provided by M as authorized devices for PIN. This 5G home access router uses 3.7 GHz frequency to connect to operator M's 5G network and also supports connectivity with Wi-Fi and Bluetooth. This 5G access router also acts as service platform which allow user to host some authorized local applications, some of whose providers are partnering with the operator M.
Today is the game night, Tom invites his friend Mike, James and Howard to his house to try the new air-combat video game that he just bought recently. The air-combat video game provider has partnership with the Operator M which hosts the game edge server in its network. Tom installed a local version of the game application in his home access platform in the 5G home access router.
Mike, James and Howard bring their own wireless game consoles as well as wireless VR glasses. Mike, James's console and VR glasses are 5G capable of supporting 26G spectrum with the subscription of operator M. Howard has the subscription of Operator A for his 5G game console and VR glasses, but the console and VR glasses support WLAN and Bluetooth®.

Service Flows
1. After his friends arrive, Tom turns on its PIN function in his 5G access router. This 5G router sends on-demand PIN creation authentication and authorization request to Operator M, for creating a PIN in this device for 4 hours in his house using mmWave spectrum owned by M. Per the subscription Tom bought, the maximum number of devices to be allowed in this PIN is 10, and tonight he only requires 8 devices. Because the on-demand PIN subscription which Tom bought is the basic and only allows local traffic, it means that guest devices in this PIN will not be able to access services outside the PIN. The PIN subscription also has other restrictions, such as the PIN only allowed operating in Tom's house and for maximum 10 hours for each time the PIN being created.
2. After being authorized by M, this 5G access router is reconfigured by PLMN remotely, which may include getting some necessary functions downloaded from M, to be able to act as PIN gateway.
3. When the 5G access router is ready, it starts to use and broadcast its own PIN network ID which can be assigned by M or named by Tom depended on the M's policy.
4. Mike and James have connected to Tom's game night PIN before on other game nights, so their devices automatically discover and connect their 5G game consoles and VR glasses to this PIN after being authenticated & authorized via Tom's 5G router. It's Howard first time to use PIN since he has no subscription of M, he has to manually select and connect his game console to “game night” PIN using WLAN.
5. An edge server function is created and hosted in the 5G router after the PIN is up, so everyone's game consoles can be connected to that local game edge server application for playing locally. Before coming to Tom's house, James played the game at his home and his game console was connected to the game edge server in the PLMN's cloud. After being connected to “game night” PIN, Tom's connection with the game edge server is relocated to the local game edge server in the “game night” PIN. Within this PIN, Tom, Mike, James's game consoles and VR glasses can communicate with each other using D2D with the mmWave spectrum, while Howard's console can communicate with others' consoles via the connection to Tom's 5G access router using WLAN first.
6. Tom's 5G access router monitors and controls the communication of those devices in “game night” PIN based on the policy from M, also may coordinate with M for some necessary network managements, such as interference management.
7. All the gaming content being exchanged between these players is conveyed locally, only the game status information can be conveyed back to the central game server in the cloud via the local game function in Tom's 5G router.
Post-conditions
Tom, Mike, James and Howard play the game in Tom's house for 3 hours. After 3 hours, Tom sends the PIN termination request to M, then the “game night” PIN is terminated. All the game consoles and VR glasses are disconnected from the PIN. 5G access route sends the charging information for this 3-hour operation of PIN.

What is claimed is:

1. A method comprising:
receiving, by a user equipment (UE), active service time information of a first network, the active service time information indicating an expiration time of operation of the first network or a service provided by the first network; and
determining, by the UE, whether to select the first network for access based on the active service time information and a network selection policy, the network selection policy comprising information indicating one or more requirements that are based on network active service time.

2. The method of claim 1, wherein the active service time information comprises one or more of following:
an operation duration of the first network, a remaining operation time of the first network, an operation starting time of the first network, an operation ending time of the first network, a notification of an end of the operation of the first network, a counter value reduced by a pre-defined number at a pre-defined interval, a service operation duration of the service, a starting time of the service, a remaining service operation time of the service, an ending time of the service, or a service notification of an end of the service.

3. The method of claim 1, wherein the network selection policy specifies that a network is selectable by the UE when the network satisfies the one or more requirements.

4. The method of claim 1, wherein the one or more requirements comprise:
a minimum remaining operation time required for a network selectable by the UE, or
a restriction on starting and ending time of operation of the network selectable by the UE.

5. The method of claim 1, wherein the network selection policy is received by the UE in a UE parameter update (UPU) message, a UE configuration update (UCU) message, or a control message for network selection configuration.

6. The method of claim 1, further comprising:
upon determining to access the first network, setting, by the UE, a timer according to the expiration time of the operation of the first network or the service; and
accessing, by the UE, the first network for a first service according to the timer.

7. The method of claim 6, further comprising:
terminating, by the UE, the first service with the first network when or before the timer expires.

8. The method of claim 6, further comprising:
initiating, by the UE before the timer expires, a service continuity procedure to move the first service from the first network to a second network.

9. The method of claim 6, further comprising:
requesting, by the UE, to extend an expiration time of the first service for the UE.

10. The method of claim 1, further comprising:
receiving, by the UE, updated active service time information of the first network.

11. A method comprising:
transmitting, by a first network, active service time information indicating an expiration time of operation of the first network or a service provided by the first network, the active service time information enabling one or more user equipments (UEs) to determine whether to access the first network for one or more services provided by the first network; and
providing, by the first network, a first service to a first UE according to the expiration time.

12. The method of claim 11, wherein the active service time information comprises one or more of following:
an operation duration of the first network, a remaining operation time of the first network, an operation starting time of the first network, an operation ending time of the first network, a notification of an end of the operation of the first network, a counter value reduced by a pre-defined number at a pre-defined interval, a service operation duration of the service, a starting time of the service, a remaining service operation time of the service, an ending time of the service, or a service notification of an end of the service.

13. The method of claim 11, wherein the active service time information is transmitted:
in a system information block (SIB);
during a procedure for network registration, service request, service modification or service termination of the first UE with the first network; or
during a second procedure for packet data unit (PDU) session establishment, PDU session modification or PDU session termination of the first UE with the first network.

14. An apparatus comprising:
a non-transitory memory storing instructions; and
at least one processor in communication with the non-transitory memory, the at least one processor configured, upon execution of the instructions, cause the apparatus to perform operations including:
receiving active service time information of a first network, the active service time information indicating an expiration time of operation of the first network or a service provided by the first network; and
determining whether to select the first network for access based on the active service time information and a network selection policy, the network selection policy comprising information indicating one or more requirements that are based on network active service time.

15. The apparatus of claim 14, wherein the active service time information comprises one or more of following:
an operation duration of the first network, a remaining operation time of the first network, an operation starting time of the first network, an operation ending time of the first network, a notification of an end of the operation of the first network, a counter value reduced by a pre-defined number at a pre-defined interval, a service operation duration of the service, a starting time of the service, a remaining service operation time of the service, an ending time of the service, or a service notification of an end of the service.

16. The apparatus of claim 14, wherein the one or more requirements comprise:
a minimum remaining operation time required for a network selectable by the UE, or a restriction on starting and ending time of operation of the network selectable by the UE.

17. The apparatus of claim 14, the at least one processor configured, upon execution of the instructions, cause the apparatus to perform operations further including:
upon determining to access the first network, setting, by the UE, a timer according to the expiration time of the operation of the first network or the service; and
accessing, by the UE, the first network for a first service according to the timer.

18. The apparatus of claim 14, the at least one processor configured, upon execution of the instructions, cause the apparatus to perform operations further including:
initiating, by the UE before the timer expires, a service continuity procedure to move the first service from the first network to a second network.
